(19) United States
(12) Patent Application Publication
(10) Pub. No.: US 2021/0126275 A1
(43) Pub. Date: Apr. 29, 2021

(54) ELECTROCHEMICAL DEVICE

(71) Applicant: ElringKlinger AG, Dettingen (DE)

(72) Inventors: Peter Stahl, Metzingen (DE); Juergen Kraft, Metzingen (DE)

(21) Appl. No.: 17/139,479

(22) Filed: Dec. 31, 2020

Related U.S. Application Data
(63) Continuation of application No. PCT/EP2019/067370, filed on Jun. 28, 2019.

(30) Foreign Application Priority Data
Jul. 2, 2018 (DE) 10 2018 115 983.8

(51) Int. Cl. H01M 8/2483; H01M 8/0258; H01M 8/0286; H01M 8/0276; C25B 9/77; C25B 13/02

(52) U.S. Cl. CPC H01M 8/2483; H01M 8/0258; H01M 8/0286; H01M 2008/1095; C25B 9/77; C25B 13/02; H01M 8/0276

(57) ABSTRACT

An electrochemical device is provided, including: a stack of a plurality of electrochemical units succeeding one another along a stacking direction, each including an electrochemically active membrane electrode arrangement, a bipolar plate, and a sealing system; at least one medium channel extending along the stacking direction through a plurality of electrochemical units; and a flow field via which a medium from the medium channel can flow transversely to the stacking direction to another medium channel. The sealing system includes a flow field sealing arrangement extending around a flow field, and a medium channel sealing arrangement extending around a medium channel. The flow field sealing arrangement is fixed to the membrane electrode arrangement and the medium channel sealing arrangement is fixed to the bipolar plate.

### CROSS-REFERENCE TO RELATED APPLICATIONS

This application is a continuation of international application number PCT/EP2019/067370, filed on Jun. 28, 2019, which claims the benefit of German application number 10 2018 115 983.8, filed on Jul. 2, 2018, which are incorporated herein by reference in their entirety and for all purposes.

### FIELD OF DISCLOSURE

The present invention relates to an electrochemical device, which comprises the following:

a stack of a plurality of electrochemical units succeeding one another along a stacking direction, which each comprise an electrochemically active membrane electrode arrangement, a bipolar plate, and a sealing system,

at least one medium channel, which extends along the stacking direction through a plurality of the electrochemical units, and

at least one flow field by means of which a medium from the medium channel is able to flow transversely to the stacking direction from the medium channel to another medium channel,

wherein the sealing system comprises a flow field sealing arrangement, which extends around at least one flow field, and at least one medium channel sealing arrangement, which extends around a medium channel.

### BACKGROUND OF THE INVENTION

In known electrochemical devices of this type, the sealing system is connect to one or more gas diffusion layers of the membrane electrode arrangement, such that a so-called seal on GDL unit is created. However, here there are large regions of the sealing system, primarily in the region of the medium channel sealing arrangements, that are mechanically unstable. Only the regions of the sealing system in the vicinity of the gas diffusion layers, in particular regions of the flow field sealing arrangement, are stabilized by the mechanical rigidity of the gas diffusion layers.

In the case of large cell designs with large medium channel regions, these mechanically unstable regions of the sealing system are disadvantageous in the mounting process of the electrochemical device, in particular in the assembling process of the membrane electrode arrangement itself and in the assembling process of the membrane electrode arrangement on the bipolar plate. The positioning accuracy of the sealing system in the region of the medium channels is significantly reduced by the instability of the sealing system in this region, or an adequate positioning may not be possible at all. As a result, the complexity and the costs of the mounting processes that are necessary for the production of the electrochemical device rise.

### SUMMARY OF THE INVENTION

In accordance with an embodiment of the invention, an electrochemical device of the kind state at the outset is provided in which the sealing system has a high mechanical stability and is precisely positionable in the mounting the electrochemical device.

In accordance with an embodiment of the invention, an electrochemical device with the features of the preamble of claim 1 is provided in which the flow field sealing arrangement is fixed to the membrane electrode arrangement and the at least one medium channel sealing arrangement is fixed to the bipolar plate.

The concept underlying the solution in accordance with the invention is to mechanically stabilize the regions of the sealing system that are further away from the membrane electrode arrangement, in particular from the gas diffusion layers, by means of connection to the bipolar plate, and thus to improve the positioning accuracy of said regions in the mounting of the electrochemical device.

The flow field sealing arrangement, however, which seals the electrochemically active region of an electrochemical unit and is located in the direct vicinity of the membrane electrode arrangement, is connected to the membrane electrode arrangement.

In particular, provision may be made for the membrane electrode arrangement to comprise two gas diffusion layers and for the flow field sealing arrangement to be fixed to at least one of the gas diffusion layers.

In this case, the flow field sealing arrangement together with the at least one gas diffusion layer forms a seal on GDL unit.

In particular, provision may be made for the flow field sealing arrangement to comprise two flow field sealing elements, of which each is fixed to a respective one of the gas diffusion layers.

In this case, the flow field sealing arrangement is thus of multi-part, in particular two-part, configuration.

The bipolar plate may in particular comprise at least two bipolar plate layers, and the medium channel sealing arrangement may comprise a medium channel sealing element, which is fixed to one of the bipolar plate layers or to both bipolar plate layers.

The medium channel sealing element may have been produced on one of the bipolar plate layers before the bipolar plate layers were fixed to one another. Here it is possible to support the individual bipolar plate layer, on which a sealing element is injection molded, on the side facing away from the sealing element. A tool pressing edge, which, for example, seals off an injection molding tool cavity from the environment, may be placed on the bipolar plate layer with sufficient contact pressure during the production of the medium channel sealing element.

So as to not damage the medium channel sealing element produced on a bipolar plate layer when joining the bipolar plate layers to form the bipolar plate, it is favorable if the bipolar plate layers are fixed to one another along connecting lines, in particular welding lines, which do not cross the medium channel sealing element, seen along the stacking direction.

In an alternative embodiment of the electrochemical device, provision is made for the medium channel sealing element to have been produced on one of the bipolar plate layers after the bipolar plate layers were fixed to one another. In this case, damage to the medium channel sealing element as a result of the joining operation, by means of which the bipolar plate is formed from the bipolar plate layers, is excluded from the outset.

The medium channel sealing arrangement may be produced e.g. by means of an injection molding operation.

Alternatively hereto, provision may be made for the medium channel sealing arrangement to be produced by means of a screen printing operation.

In a particular embodiment of the invention, provision is made for the medium channel sealing arrangement to be arranged on, in particular fixed to, a bead that is formed in a bipolar plate layer of the bipolar plate.

Further, provision may be made for the medium channel sealing arrangement, in the mounted state of the electrochemical device, to abut in a fluid-tight manner against a bead that is formed in a bipolar plate layer of a bipolar plate.

The height h of the medium channel sealing arrangement is preferably smaller than the height H₁ of the bead to which the medium channel sealing arrangement is fixed, and/or smaller than the height H₂ of the bead against which the medium channel sealing arrangement abuts in a fluid-tight manner in the mounted state of the electrochemical device.

Alternatively or in addition hereto, provision may be made for the height h of the medium channel sealing arrangement to be smaller than the sum of the heights H₁ and H₂.

In this description and the accompanying claims, the height of an element is to be understood as the extent thereof along the stacking direction.

If the medium channel and the flow field are in fluidic connection with one another by means of a flow port, the flow port thus preferably comprises a medium through-opening, which is formed in the bead to which the medium channel sealing arrangement is fixed, or is formed in the bead against which the medium channel sealing arrangement abuts in a fluid-tight manner in the mounted state of the electrochemical device.

The medium through-opening is thereby preferably formed on the side of the respective bead facing toward the medium channel.

If one of the bipolar plate layers of the bipolar plate has an edge web running around the flow field, provision may thus be made for a medium through-opening to be formed in the edge web.

Such a medium through-opening may, in particular, form a constituent part of a flow port, by means of which the medium channel and the flow field are in fluidic connection with one another.

The medium through-opening formed in the edge web is thereby preferably arranged on the side of the edge web facing toward the flow field.

The flow field sealing arrangement may in particular be produced by means of an injection molding operation, a screen printing operation, or a dispenser application operation.

The present invention further relates to a method for producing an electrochemical device, which comprises

a stack of a plurality of electrochemical units succeeding one another along a stacking direction, which each comprise an electrochemically active membrane electrode arrangement, a bipolar plate, and a sealing system,

at least one medium channel which extends along the stacking direction through a plurality of the electrochemical units, and

at least one flow field by means of which a medium from the medium channel is able to flow transversely to the stacking direction from the medium channel to another medium channel,

wherein the sealing system comprises a flow field sealing arrangement, which extends around at least one flow field, and at least one medium channel sealing arrangement, which extends around a medium channel.

Underlying the present invention is the further object to create such a method for producing an electrochemical device, by means of which method a high mechanical stability and a high positioning accuracy of the sealing system in the production of the electrochemical device is achieved.

This object is achieved in accordance with the invention by a method of the aforementioned type, which comprises the following:
producing the flow field sealing arrangement on the membrane electrode arrangement;
producing the at least one medium channel sealing arrangement on the bipolar plate.

Particular embodiments of the method in accordance with the invention have already been described above in conjunction with particular embodiments of the electrochemical device in accordance with the invention.

The method in accordance with the invention is suited in particular for producing an electrochemical device in accordance with the invention.

The electrochemical device may be configured, in particular, as a fuel cell device or as an electrolyzer.

The fuel cell device may be configured, in particular, as a polymer electrolyte membrane fuel cell device.

The bipolar plate may comprise one or more individual layers.

The membrane electrode unit may comprise, in particular, a membrane, an anode-side catalyst element, a cathode-side catalyst element, and preferably two gas diffusion layers.

The electrochemical device comprises manifolds or media channels via which fluid media, in particular an oxidizing agent, a fuel gas, and/or a cooling agent, can, in the stacking direction of the electrochemical device, be supplied to the electrochemical units and be discharged from the electrochemical units.

The electrochemical device may comprise flow ports, via which in each case a fluid medium from a medium channel can be supplied to a flow field or to the electrochemically active region of an electrochemical unit, or via which in each case a fluid medium can be discharged from the flow field or from the electrochemically active region of the electrochemical unit to a medium channel.

The sealing system seals off the media spaces for the anode-side fluid medium, the cathode-side fluid medium, and optionally the cooling agent from one another and from the environment.

The flow field sealing arrangement extends around the electrochemically active region of the electrochemical unit.

Each of the medium channel sealing arrangements extends around a respective medium channel or around a medium through-opening in the bipolar plate.

The flow field sealing arrangement, which extends around the electrochemically active region, is connected to the membrane electrode arrangement.

The medium channel sealing arrangements, which extend around a respective medium channel, are connected to the bipolar plate.

The flow field sealing arrangement may be connected to the entire membrane electrode arrangement or to one or more components of the membrane electrode arrangement.

The flow field sealing arrangement may consist of two parts, which each are connected to one of the two gas diffusion layers of the membrane electrode arrangement.

The medium channel sealing arrangement and/or the flow field sealing arrangement may be produced by means of injection molding, screen printing, dispenser application, or by means of a similar process.

Each of the medium channel sealing arrangements may each be connected to an individual layer of the bipolar plate or to a bipolar plate consisting of a plurality of individual layers.

The process in which the respective medium channel sealing arrangement is produced on the bipolar plate may be followed by a joining process, in particular a welding process, in which a plurality of layers of the bipolar plate are joined together, in particular welded together.

Further features and advantages of the invention are subject matter of the subsequent description and the graphical representation of exemplary embodiments.

### BRIEF DESCRIPTION OF THE DRAWINGS

FIG. 1 shows a sectional schematic plan view of an electrochemical unit of an electrochemical device comprising a plurality of electrochemical units succeeding one another along a stacking direction, in the region of an oxidizing agent supply, a cooling agent supply, and a residual fuel gas discharge;

FIG. 2 shows a schematic section through the oxidizing agent supply of the electrochemical unit from FIG. 1 along line 2-2 in FIG. 1;

FIG. 3 shows a sectional schematic plan view of a second embodiment of an electrochemical unit of an electrochemical device comprising a plurality of electrochemical units succeeding one another along a stacking direction, in the region of a residual fuel gas discharge, a cooling agent supply, and an oxidizing agent supply; and

FIG. 4 shows a schematic section through the fuel gas supply of the electrochemical unit from FIG. 3, along line 4-4 in FIG. 3.

The same or functionally equivalent elements are provided with the same reference numerals in all Figures.

### DETAILED DESCRIPTION OF THE INVENTION

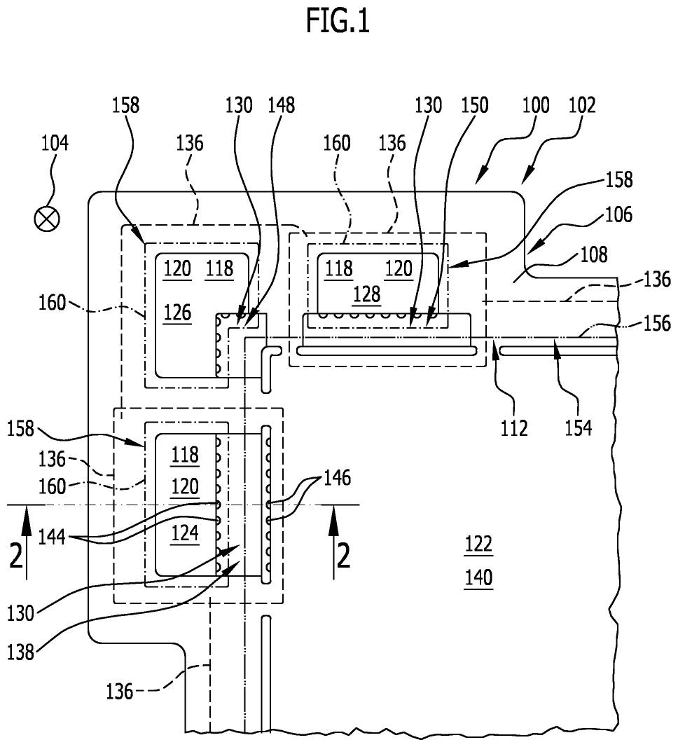

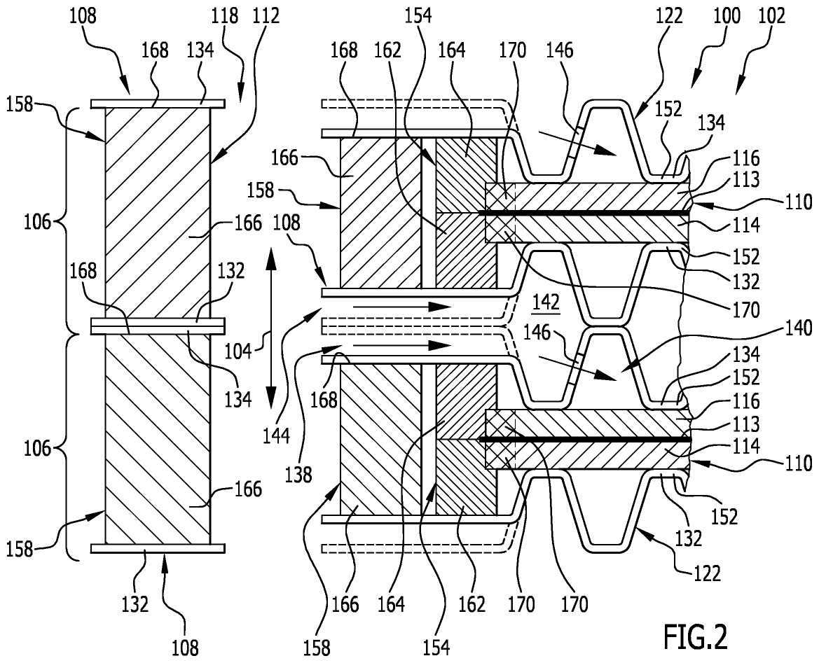

An electrochemical device, for example a fuel cell device or an electrolyzer, which is depicted in FIGS. 1 and 2 and is denoted as a whole with 100, comprises a stack 102 that comprises a plurality of electrochemical units 106, for example fuel cell units or electrolyzer units, succeeding one another in a stacking direction 104, and a clamping device (not depicted) for applying the electrochemical units with a clamping force directed along the stacking direction 104.

As can be seen best in FIG. 2, each electrochemical unit 106 of the electrochemical device 100 comprises in each case a bipolar plate 108, a membrane electrode arrangement (MEA) 110, and a sealing system 112.

The membrane electrode arrangement 110 comprises e.g. a catalyst-coated membrane (CCM) 113 and two gas diffusion layers 114 and 116, wherein a first gas diffusion layer 114 is arranged on the anode side and a second gas diffusion layer 116 is arranged on the cathode side.

The bipolar plate 108 is formed e.g. of a metallic material.

The bipolar plate 108 has a plurality of medium through-openings 118, through which in case a fluid medium to be supplied to the electrochemical device 100 (in the case of a fuel cell device e.g. a fuel gas, an oxidizing agent, or a cooling agent) is able to pass through the bipolar plate 108.

The medium through-openings 118 of the bipolar plates 108 succeeding one another in the stack 102 and the interspaces located between the medium through-openings 118 in the stacking direction 104 together each form a medium channel 120.

Each medium channel 120 by means of which a fluid medium is suppliable to the electrochemical device 100 is associated with at least one respective other medium channel by means of which the respective fluid medium is dischargeable from the electrochemical device 100.

By means of a flow field 122 located therebetween, which is preferably formed on a surface of an adjacent bipolar plate 108 or (for example in the case of a cooling agent flow field) in the interspace between the layers of a multi-layer bipolar plate 108, the medium is able to flow transversely, preferably substantially perpendicularly, to the stacking direction 104 from the first medium channel 120 to the second medium channel.

Depicted in FIG. 1 is e.g. a medium channel 124 for an oxidizing agent of the electrochemical device 100, a medium channel 126 for a cooling agent of the electrochemical device 100, and a medium channel 128 for a fuel gas or a residual fuel gas of the electrochemical device 100.

Each medium channel 120 is in fluidic connection with the respectively associated flow field 122 by means of a respective flow port 130.

In the embodiment depicted in the drawings, each bipolar plate 108 comprises a first bipolar plate layer 132 and a second bipolar plate layer 134 which are fixed to one another in a fluid-tight manner, preferably in a materially-bonded manner, in particular by means of welding, for example by means of laser welding, along connecting lines 136, which are depicted in FIG. 1 with broken lines.

As can be seen in FIG. 1, the medium channel 124 for oxidizing agent is in fluidic connection with a flow field 140 for the oxidizing agent by way of a flow port 138 for oxidizing agent, said flow field 140 being formed between the second bipolar plate layer 134 and the second gas diffusion layer 116.

The flow port 138 comprises a connecting chamber 142 that is formed by an intermediate space between the first bipolar plate layer 132 and the second bipolar plate layer 134 and is in fluidic connection with the medium channel 124 by way of inlet openings 144 facing toward the medium channel 124 for oxidizing agent and is in fluidic connection with the flow field 140 by way of outlet openings 146 facing toward the flow field 140 for the oxidizing agent.

As can be further seen in FIG. 1, the medium channel 126 for cooling agent is in fluidic connection with a flow field for the cooling agent by way of a flow port 148 for cooling agent, which is formed by an interspace between the first bipolar plate layer 132 and the second bipolar plate layer 134 of the bipolar plate 108, said flow field being formed in the interspace between the first bipolar plate layer 132 and the second bipolar plate layer 134.

The medium channel 128 for fuel gas or residual fuel gas is in fluidic connection with a flow field for the fuel gas by way of a flow port 150 for fuel gas, said flow field being formed between the first bipolar plate layer 132 and the first gas diffusion layer 114.

In order to guide the flow of the media through the respectively associated flow fields 122, the first bipolar plate layer 132 and the second bipolar plate layer 134 of the bipolar plate 108 are provided in the region of the flow fields 122 with flow guiding elements 152, which may be configured e.g. in the form of raised beads.

Undesired leakage of the fluid media from the media channels 120 and the flow fields 122 of the electrochemical device is avoided by means of the sealing system 112.

The sealing system 112 comprises a flow field sealing arrangement 154, which extends around the flow fields 122. The sealing lines 156 of said flow field sealing arrangement 154 are depicted in the plan view of FIG. 1 by means of dashed-double point lines.

Further, the sealing system 112 comprises a plurality of medium channel sealing arrangements 158, which each extend around a medium channel 120. The sealing lines 160 of said medium channel sealing arrangements 158 are depicted in the plan view of FIG. 1 by means of dot-dash lines.

As can be best seen in FIG. 2, the flow field sealing arrangement 154 comprises a first flow field sealing element 162, which is fixed to the (anode-side) first gas diffusion layer 114, and a second flow field sealing element 164, which is fixed to the (cathode-side) second gas diffusion layer 116.

The flow field sealing elements 162 and 164 are preferably produced on the respectively associated gas diffusion layer 114 or 116 by means of an injection molding operation, a screen printing operation, or a dispenser application operation.

The flow field sealing elements 162 and 164 preferably comprise an elastomer material and may be formed in particular substantially completely of an elastomer material.

The flow field sealing elements 162 and 164, in the mounted state of the electrochemical device 100, preferably abut against one another in a fluid-tight manner, without being fixed to one another.

The first flow field sealing element 162 and the second flow field sealing element 164 are preferably of congruent configuration, seen in the stacking direction 104.

Each of the flow field sealing elements 162 and 164, in the mounted state of the electrochemical device 100, abuts against a respective bipolar plate layer 132 and 134, respectively, in a fluid-tight manner, without being fixed to the respective bipolar plate layer 132 or 134.

Each of the medium channel sealing arrangements 158 preferably comprises a respective medium channel sealing element 166, which is fixed to one of the bipolar plate layers 132 or 134 of the bipolar plate 108, for example to the first bipolar plate layer 132.

In the mounted state of the electrochemical device 100, the medium channel sealing element 166 abuts with a sealing face 168 against the bipolar plate 108 of an adjacent electrochemical unit 106 in the stacking direction 104.

The medium channel sealing element 166 may be produced on the bipolar plate 108 e.g. by means of means of an injection molding operation, a screen printing operation, or a dispenser application operation.

The medium channel sealing element 166 preferably comprises an elastomer material and is formed in particular substantially completely of an elastomer material.

The medium channel sealing element 166 may have been produced on one of the bipolar plate layers 132, 134 of the bipolar plate 108 after the bipolar plate layers 134 and 134 were fixed to one another.

Alternatively hereto, provision may be made for the medium channel sealing element 166 to have been produced on one of the bipolar plate layers 132, 134 before the bipolar plate layers 132 and 134 were fixed to one another.

In this case, it is favorable if the connecting lines 142, in particular welding lines, along which the bipolar plate layers 132 and 134 are fixed to one another do not cross the medium channel sealing element 166, seen along the stacking direction 104, such that damage to the medium channel sealing arrangement 158 is avoided during the connecting operation of the bipolar plate layers 132 and 134, in particular during a welding operation, by means of which the bipolar plate layers 132 and 134 are fixed to one another.

In the electrochemical device 100 depicted in FIGS. 1 and 2, the medium channel sealing arrangements 158, which extend around the medium channels 120, have been produced in a working operation on the bipolar plate 108 of the respective electrochemical unit 106.

The flow field sealing elements 162 and 164 of the flow field sealing arrangement 154 have each been produced on one of the gas diffusion layers 114 and 116, respectively.

As a result of the connection of the large medium channel sealing arrangements 158 to the bipolar plate 108, in particular in a tool-dependent process (for example in an injection molding operation or in a screen printing operation) the complex positioning of the sealing system 112 in the region of the medium channels 120 relative to the bipolar plate 108 that would otherwise be necessary is not required in the assembly of the electrochemical device 100.

The positional tolerance of the sealing system 112 on the bipolar plate 108 thus consists only of the positional tolerance of the bipolar plate 108 in the tool that is used for producing the medium channel sealing arrangements 158, and the production tolerance, in particular the tool tolerance, of the medium channel sealing arrangements 158.

Each of the gas diffusion layers 114 and 116, together with the respective flow field sealing element 162 or 164 arranged thereon, which may be of relatively narrow configuration and extends around the respectively associated gas diffusion layer 114 or 116, forms in each case a seal on GDL unit 170 which, due to the mechanical rigidity of the respective gas diffusion layer 114 or 116, is very dimensionally stable and thus is easy to position when mounting the electrochemical device 100.

Upon the mounting of the electrochemical device 100, the two seal on GDL units 170 are assembled together with the membrane 113 of the membrane electrode arrangement 110.

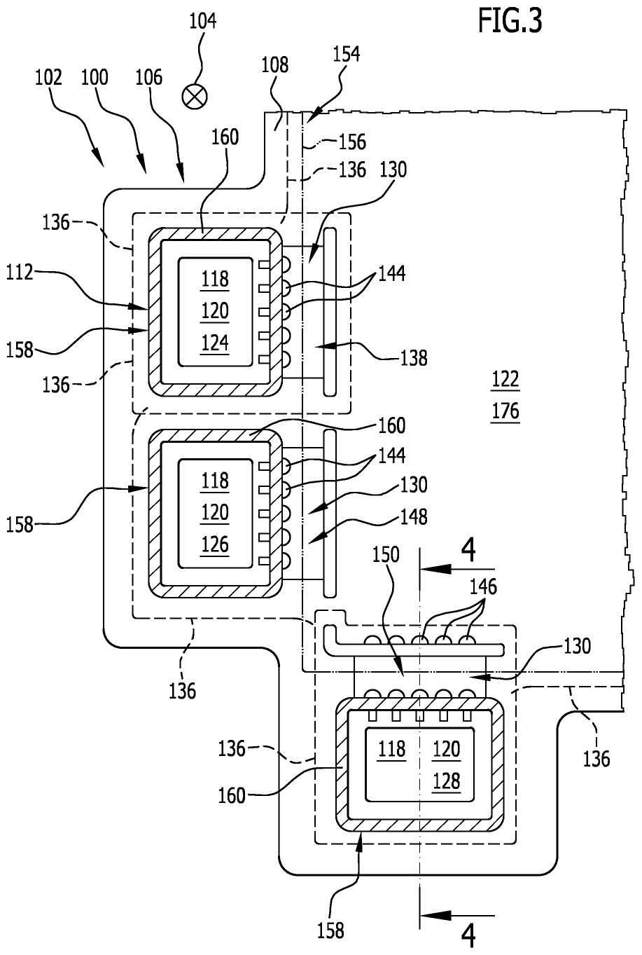

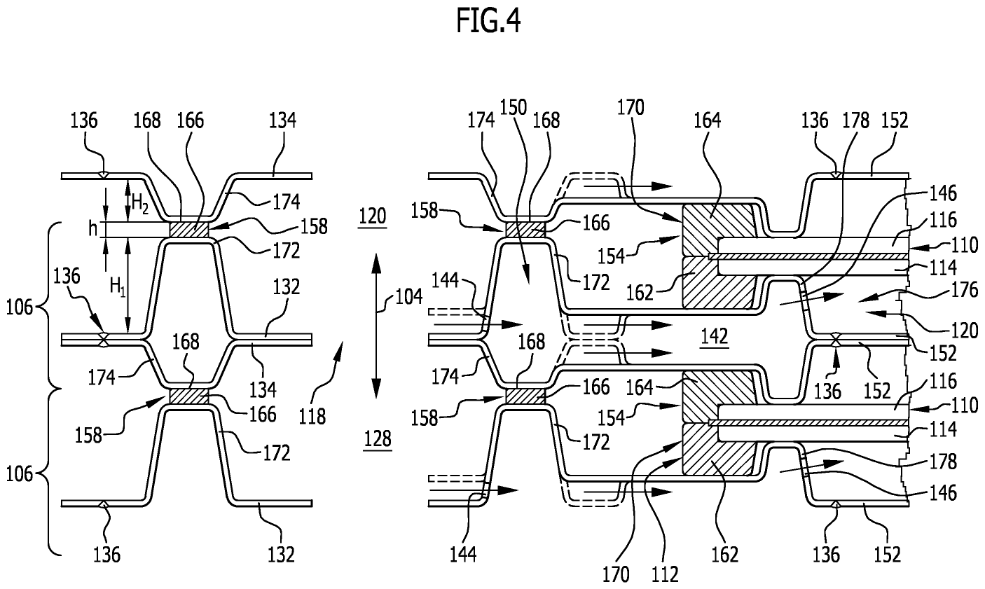

A second embodiment, depicted in FIGS. 3 and 4, of an electrochemical device 100 differs from the first embodiment depicted in FIGS. 1 and 2 in that the medium channel sealing arrangements 158 are each fixed to a bead 172 that is formed in one of the bipolar plate layers 132, 134 of the bipolar plate 108.

The height h of the medium channel sealing arrangement 158 is thereby preferably smaller than the height H₁ of the bead 172 in the bipolar plate layer 132 and 134, respectively, to which the medium channel sealing arrangement 158 is fixed.

In this embodiment as well, in the mounted state of the electrochemical device 100, the medium channel sealing arrangement 158 abuts by way of a sealing face 168 against the bipolar plate 108 of an adjacent electrochemical unit 106 in the stacking direction 104.

Thereby, a bead 174, against which the medium channel sealing arrangement 158 abuts, is preferably also formed in the bipolar plate layer 134 and 132, respectively, against which the medium channel sealing arrangement 158 abuts with the sealing face 168 in a fluid-tight manner.

The height h of the medium channel sealing arrangement 158 is preferably smaller than the height H₂ of the bead 174 in the bipolar plate layer 134 or 132, against which the medium channel sealing arrangement 158 abuts in a fluid-tight manner in the mounted state of the electrochemical device 100.

But at least it is favorable if the height h of the medium channel sealing arrangement 158 is smaller than the sum of the height H₁ of the bead 172 in the bipolar plate layer 132 or 134 to which the medium channel sealing arrangement 158 is fixed, and the height H₂ of the bead 174 in the bipolar plate layer 134 or 132 against which the medium channel sealing arrangement 158 abuts in a fluid-tight manner in the mounted state of the electrochemical device 100, without being fixed to the same.

As a result of the beads 172, 174 provided in the bipolar plate layers 132, 134, the necessary height h of the medium channel sealing arrangement 158 in the region of said beads 172, 174 is reduced, such that, in particular, less elastomer material is required for the production of the medium channel sealing arrangement 158.

It is therefore, in particular, simpler to attach the medium channel sealing arrangement 158 to one of the bipolar plate layers 132, 134 by means of a screen printing operation.

Because no tool needs to be pressed against the bipolar plate 108 with a high contact pressure when producing the medium channel sealing arrangement 158 by means of a screen printing operation, the medium channel sealing arrangement 158 can be easily produced on the bipolar plate 108 after the two bipolar plate layers 132 and 134 have been fixed to one another, for example by means of a welding operation.

The fixing of the two bipolar plate layers 132 and 134 to one another, in particular by means of a welding operation, in this case may take place before a seal has been produced on the bipolar plate layers 132, 134, such that there is no risk of such a seal being contaminated by the joining operation.

Further, in this case, the connecting lines 136, in particular the welding lines, along which the two bipolar plate layers 132 and 134 are fixed to one another can readily cross the medium channel sealing arrangements 158, seen in the stacking direction 104, because the medium channel sealing arrangements 158 are produced only after the connection of the bipolar plate layers 132 and 134 to one another, and thus no damage to the medium channel sealing arrangements 158 can occur in the joining operation of the bipolar plate layers 132 and 134.

FIG. 4 shows a schematic section through the second embodiment of the electrochemical device 100 in the region of a flow port 150 for the fuel gas.

The flow port 150 comprises a connecting chamber 142 that is formed by an intermediate space between the first bipolar plate layer 132 and the second bipolar plate layer 134 and is in fluidic connection with the medium channel 128 by way of inlet openings 144 facing toward the medium channel 128 for fuel gas or residual fuel gas and is in fluidic connection with the flow field 176 by way of outlet openings 146 facing toward the flow field 176 for the fuel gas.

The inlet openings 144 are preferably formed in the bead 172 on which the medium channel sealing arrangement 158 is arranged, namely preferably on the side of the bead 172 facing toward the medium channel 120.

The outlet openings 146 of the flow port 130 are preferably formed in an edge web 178 which extends around the flow field 120, in particular the flow field 176 for the fuel gas, namely preferably on the side of the edge web 178 facing toward the flow field 120.

In the region of the flow ports 130, the flow field sealing arrangement 154 preferably has a smaller height than in portions located outside of the flow ports 130.

In all other respects, the second embodiment of an electrochemical device 100 depicted in FIGS. 3 and 4 corresponds with respect to structure, function, and production method with the first embodiment depicted in FIGS. 1 and 2, to the preceding description of which reference is made in this regard.

1. An electrochemical device, comprising
a stack of a plurality of electrochemical units succeeding one another along a stacking direction, which each comprise an electrochemically active membrane electrode arrangement, a bipolar plate, and a sealing system,
at least one medium channel, which extends along the stacking direction through a plurality of the electrochemical units, and
at least one flow field by means of which a medium from the medium channel is able to flow transversely to the stacking direction from the medium channel to another medium channel,
wherein the sealing system comprises a flow field sealing arrangement, which extends around at least one flow field, and
at least one medium channel sealing arrangement, which extends around a medium channel,
wherein the flow field sealing arrangement is fixed to the membrane electrode arrangement and the at least one medium channel sealing arrangement is fixed to the bipolar plate.

2. The electrochemical device in accordance with claim 1, wherein the membrane electrode arrangement comprises two gas diffusion layers and the flow field sealing arrangement is fixed to at least one of the gas diffusion layers.

3. The electrochemical device in accordance with claim 2, wherein the flow field sealing arrangement comprises two flow field sealing elements, each of which is fixed to a respective one of the gas diffusion layers.

4. The electrochemical device in accordance with claim 1, wherein the bipolar plate comprises at least two bipolar plate layers and the medium channel sealing arrangement comprises a medium channel sealing element that is fixed to one of the bipolar plate layers or to both bipolar plate layers.

5. The electrochemical device in accordance with claim 4, wherein the medium channel sealing element has been produced on one of the bipolar plate layers before the bipolar plate layers were fixed to one another.

6. The electrochemical device in accordance with claim 5, wherein the bipolar plate layers are fixed to one another along connecting lines and the connecting lines do not cross the medium channel sealing element, seen along the stacking direction.

7. The electrochemical device in accordance with claim 4, wherein the medium channel sealing element has been produced on one of the bipolar plate layers after the bipolar plate layers were fixed to one another.

8. The electrochemical device in accordance with claim 1, wherein the medium channel sealing arrangement is produced by means of an injection molding operation.

9. The electrochemical device in accordance with claim 1, wherein the medium channel sealing arrangement is produced by means of a screen printing operation.

10. The electrochemical device in accordance with claim 1, wherein the medium channel sealing arrangement is arranged on a bead that is formed in a bipolar plate layer of the bipolar plate.

11. The electrochemical device in accordance with claim 10, wherein the height of the medium channel sealing arrangement is smaller than the height of the bead.

12. The electrochemical device in accordance with claim 10, wherein the medium channel and the flow field are in fluidic connection with one another by means of a flow port and the flow port comprises a medium through-opening, which is formed in the bead.

13. The electrochemical device in accordance with claim 1, wherein one of the bipolar plate layers of the bipolar plate has an edge web running around the flow field and a medium through-opening is formed in the edge web.

14. The electrochemical device in accordance with claim 1, wherein the flow field sealing arrangement is produced by means of an injection molding operation, a screen printing operation, or a dispenser application operation.

15. A method for producing an electrochemical device, which comprises
a stack of a plurality of electrochemical units succeeding one another along a stacking direction, which each comprise an electrochemically active membrane electrode arrangement, a bipolar plate, and a sealing system,
at least one medium channel, which extends along the stacking direction through a plurality of the electrochemical units, and
at least one flow field, by means of which a medium from the medium channel is able to flow transversely to the stacking direction from the medium channel to another medium channel,
wherein the sealing system comprises a flow field sealing arrangement, which extends around at least one flow field, and at least one medium channel sealing arrangement, which extends around a medium channel,
wherein the method comprises the following:
producing the flow field sealing arrangement on the membrane electrode arrangement;
producing the at least one medium channel sealing arrangement on the bipolar plate.
